(19) United States
(12) Patent Application Publication
(10) Pub. No.: US 2026/0119847 A1
(43) Pub. Date: Apr. 30, 2026

(54) TASK-BASED AMBIGUITY CLARIFICATION

(71) Applicant: Adobe Inc., San Jose, CA (US)

(72) Inventors: John Murzaku, Port Jefferson, NY (US); Zifan Liu, San Jose, CA (US); Yunyao Li, San Jose, CA (US); Xiang Chen, San Jose, CA (US); Vaishnavi Muppala, San Jose, CA (US); Md mehrab Tanjim, Santa Clara, CA (US)

(73) Assignee: Adobe Inc., San Jose, CA (US)

(21) Appl. No.: 18/933,379

(22) Filed: Oct. 31, 2024

(51) Int. Cl. G06N 3/0475

(52) U.S. Cl. CPC G06N 3/0475

(57) ABSTRACT

Techniques for task-based ambiguity clarification are described that support generation of ambiguity determinations and generation of task-specific clarification questions to resolve ambiguous queries. In an example, a processing device receives a query for processing by a machine learning model. The processing device detects one or more task-based ambiguities within in the query. Based on the query and the one or more task-based ambiguities, the processing device generates a prompt for processing by the machine learning model. The machine learning model generates an ambiguity decision based on the prompt that indicates whether the query is ambiguous. The machine learning model is further configured to generate a clarification question based on the prompt to obtain additional information to resolve the one or more task-based ambiguities.

### BACKGROUND

Large language models, such as those based on neural networks and deep learning, are designed to understand, generate, and/or manipulate human language. Large language models are able to process vast amounts of data and learn patterns, and accordingly are used for a variety of applications such as language translation, dialogue recognition, and natural language understanding. For instance, large language models are often used as a component of virtual digital assistants, such as to generate natural language responses to user queries. However, large language models encounter challenges when dealing with ambiguous queries. Ambiguity in user queries, such as vague phrasing, multiple meanings, lack of context, etc., results in incorrect or irrelevant responses generated by large language models.

### SUMMARY

Techniques for task-based ambiguity clarification are described that support generation of ambiguity determinations and clarification questions in a single call of a machine learning model based on domain-specific and task-specific information. In an example, a processing device receives a query for processing by a machine learning model, such as a natural language request for a machine learning model implemented as part of a digital assistant. The processing device determines whether one or more task-based ambiguities are present within the query. For instance, the processing device leverages one or more task-based agents configured for particular domain-specific tasks of the machine learning model to detect the task-based ambiguities.

Based on the one or more task-based ambiguities and the query, the processing device generates a prompt for processing by the machine learning model. The prompt includes instructions for the machine learning model to generate an ambiguity determination that indicates whether the query as a whole is ambiguous. The prompt further includes instructions for the machine learning model to generate a clarification question to obtain additional information to resolve the one or more task-based ambiguities. The processing device then outputs a result of the processing of the prompt by the machine learning model, such as the ambiguity determination and/or the clarification question. The processing device is further operable to receive a response to the clarification question and generate a response to the query, such as based on an additional prompt for the machine learning model that includes the query and the response to the clarification question. In this way, the techniques described herein resolve ambiguities present in user queries based on domain-specific and task-specific information.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the task-based ambiguity clarification techniques described herein.

FIG. 2 depicts a system in an example implementation showing operation of a clarification module in greater detail.

FIG. 3 depicts an example of a variety of types of ambiguities present in queries.

FIG. 4 depicts an example of task-based ambiguity clarification in which a model output is generated based on a query.

FIG. 5 depicts an example of task-based ambiguity clarification in which a clarification question is generated based on a query.

FIG. 6 depicts an example of task-based ambiguity clarification in which a response to a query is generated based on the query and a response to a clarification question.

FIG. 7 depicts an example of task-based ambiguity clarification in which a clarification question is provided supplemental to a query response.

FIG. 8 is a flow diagram depicting an algorithm as a step-by-step procedure in an example implementation that is performable by a processing device to generate clarification questions and responses based on queries.

FIG. 9 is a flow diagram depicting an algorithm as a step-by-step procedure in an example implementation that is performable by a processing device to configure a prompt for processing by a machine learning model.

FIG. 10 illustrates an example system including various components of an example device that can be implemented as any type of computing device as described and/or utilized with reference to FIGS. 1-9 to implement embodiments of the techniques described herein.

### DETAILED DESCRIPTION

### Overview

Large language models (“LLM's”) are often used for a variety of natural language processing tasks such as text generation, text classification, document summarization, etc. For instance, LLM's are used in natural language generation tasks such as to be implemented by virtual chatbots to receive user queries and generate human-like responses to the user queries. However, LLM's face significant challenges when resolving ambiguity within a user query. Ambiguity in user queries, such as vague phrasing, multiple potential meanings, lack of context, etc., results in incorrect or irrelevant responses generated by large language models.

Conventional techniques, for instance, treat ambiguity resolution solely as a lexical problem and fail to incorporate domain-specific information. Accordingly, such techniques often fail to correctly identify ambiguities which results in generation of incorrect responses to user queries. These techniques further fail to leverage domain information to resolve ambiguities, which results in excessive clarification that degrades a user experience as well as a failure to generate meaningful clarification questions, particularly for domain-specific applications. Further, conventional ambiguity resolution techniques that leverage machine learning are reliant on multiple calls to the LLM, which is time consuming, frustrating for a user, and computationally inefficient.

Accordingly, techniques for task-based ambiguity clarification are described that overcome conventional limitations. For instance, a processing device receives a query to a machine learning model, such as a question provided to a large language model implemented by a virtual digital assistant. The processing device leverages a variety of downstream task-based agents to detect task-based ambiguities within the query. The task-based agents, for instance, are each configured to perform an individual task related to overall functionality of the machine learning model.

Each task-based agent is able to detect a task-based ambiguity that relates to a respective task of the machine learning model. Such tasks of the task-based agents are often configured for a particular domain, and thus one or more of the task-based ambiguities are task-specific as well as domain-specific. This overcomes the limitations of conventional techniques that fail to consider domain-specific or task-specific information during ambiguity detection and generation of clarification questions.

The processing device then configures a prompt for input to the machine learning model based on the one or more task-based ambiguities and the query. The prompt, for instance, is a multitask prompt that includes task instructions for the machine learning model to determine whether the query as a whole is ambiguous as well as task instructions that specify how to generate a clarification question. This conserves computational resources relative to conventional techniques that are reliant on multiple calls to a machine learning model.

The machine learning model then processes the prompt to generate an ambiguity determination, e.g., a decision on whether the query is ambiguous and clarification is recommended to provide an accurate response to the query. The machine learning model is further configured to process the prompt to generate a clarification question for output, e.g., in a user interface associated with the virtual digital assistant, to elicit additional information to resolve the one or more task-based ambiguities. In this way, the techniques described herein accurately generate task-specific and domain-specific clarification questions to resolve ambiguities while conserving computational resources relative to conventional techniques.

Consider an example in which a processing device receives a query for processing by a machine learning model, e.g., a large language model. The query, for instance, is a natural language request for information, task execution, search functionality, personalization, etc. such as to be performed by the machine learning model. In this example, the machine learning model is configured for a question-answering task and is implemented as part of an AI-digital assistant. For instance, the query is received as a user input to an interface that includes the AI-digital assistant, such as a question that includes the text “how do I log out.”

The processing device then detects whether the query includes one or more ambiguities. An ambiguity, for instance, represents an instance in which a meaning, intent, and/or scope of the query is unclear and/or is subject to multiple interpretations. Ambiguities thus hinder an ability of the machine learning model to generate an accurate response to the query.

In various examples, an ambiguity is “task-based” such that the ambiguity pertains to a particular task of the machine learning model. For instance, the machine learning model leverages various domain-specific task-based agents during inferencing to perform a variety of functionality. Each task-based agent is configurable for a particular task such as to identify one or more assets (e.g., products, applications, tools, etc.) within a particular domain that the query pertains to, correlate one or more strings in the query to one or more terms in a database, detect sentence level semantic properties of the query, etc. The task-based agents, for instance, enhance an ability of the machine learning model to accurately perform within a particular domain.

Accordingly, the processing device is operable to leverage the task-based agents to identify task-based ambiguities within the query. In this way, the techniques described herein are able to detect a variety of domain-specific ambiguities particular to individual tasks of the machine learning model which is not possible using conventional approaches. Continuing with the above example, the processing device leverages the one or more task-based agents to determine that there is an ambiguity particular to an asset detection task, such that the query is indeterminate and relates to multiple applications within a particular domain, each application having a respective log out procedure.

The processing device then configures a prompt for processing by the machine learning model. The prompt, for instance, is a structured input to guide the machine learning model that is based on the query as well as the one or more task-based ambiguities. For example, the prompt includes text from the query, a description of one or more task-based agents that identified task-based ambiguities, as well as a description of the task-based ambiguities, such as potential interpretations of the task-based ambiguities. Continuing with the above example, the prompt indicates the user query, a task-based agent that identified the asset detection task ambiguity, and the multiple applications that the query pertains to.

In various examples, the processing device further configures the prompt to include historical interaction data (e.g., information derived from a user chat history with the AI-digital assistant) and/or grounding information that is configured to assist the machine learning model to understand and/or interpret the query in a context of a particular domain. For instance, the grounding information includes one or more keywords and/or strings, domain-specific instructions, and/or definitions of domain-specific terms. Inclusion of the historical interaction data and the grounding information, for instance, supports an ability of the machine learning model to resolve potential ambiguities and thereby reduce incidence of over-clarification to enhance a user experience.

The processing device further configures the prompt to include instructions for the machine learning model. For instance, the prompt instructs the machine learning model to generate an ambiguity determination, such as to determine whether, as a whole the query, is ambiguous and thus a clarification question is recommended. The prompt also includes instructions for the machine learning model to generate a clarification question based on the ambiguity determination. Because the prompt is a multitask prompt, the machine learning model is operable to generate both an ambiguity determination and clarification question generation with a single call to the machine learning model (e.g., processing a single prompt), which conserves computational resources relative to conventional approaches.

The machine learning model processes the prompt to generate the ambiguity determination, such as to determine whether the query as a whole is ambiguous or is not ambiguous. In an example, the ambiguity determination indicates that the query is not ambiguous and thus the machine learning model is capable of generating an accurate answer to the query without further clarification. Accordingly, the processing device generates an additional prompt for processing by the machine learning model to generate a response to the query, such as without generation of a clarification question.

Additionally or alternatively, the ambiguity determination indicates that the query is ambiguous and thus additional information is recommended for the machine learning model to generate an accurate response to the query. Accordingly, the machine learning model generates a clarification question for output to obtain additional information to resolve the one or more task-based ambiguities present in the query. Because the prompt is based in part on one or more of the task-based agents, the machine learning model generates the clarification question to be tailored to resolve the task-based ambiguities detected in the query.

The clarification question, for instance, includes a description of the one or more task-based ambiguities as well as a request for additional information configured to resolve the one or more task-based ambiguities. Continuing with the above example, the clarification question includes an explanation of the asset-detection task ambiguity, such that the query could refer to multiple applications within a particular domain. The clarification question further includes selectable indicia, e.g., selectable options for each of the applications that the query pertains to.

The processing device is operable to receive a clarification response to the clarification question, such as a user input to select one or more of the selectable indicia. Based on the query and the clarification response, the processing device configures an additional prompt to generate an answer to the query. Continuing with the above example, the user selects a particular application included in the clarification question. The processing device generates an additional prompt based on the initial query and the user selection for input to the machine learning model to generate a response that describes how to log out of the particular application.

In this way, the techniques described herein are able to generate ambiguity determinations and clarification question in a single call of the machine learning model, which conserves computational resources relative to conventional techniques. Further, incorporation of domain-specific and/or task-specific information into the prompt supports an ability of the machine learning model to accurately identify ambiguities, resolve potential ambiguities to prevent over clarification, and generate effective clarification questions that are task-specific and thus configured to resolve task-based ambiguities. Further discussion of these and other examples and advantages are included in the following sections and shown using corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Term Examples

As used herein, the term “query” refers to an input to a machine learning model. The query, for instance, represents a natural language question and/or command provided in a user interface to a digital assistant that implements the machine learning model. In one or more examples, the query includes a natural language request for information, task execution, search functionality, personalization, etc. to be performed by the machine learning model.

As used herein, the term “prompt” refers to a structured input to guide a machine learning model to perform one or more functionalities. A prompt, for instance, is configured based on a query to guide the machine learning model to generate an ambiguity decision and/or to generate a clarification question. In one or more examples, the prompt includes one or more task instructions, properties and/or portions of the query, types of ambiguities present in the query, and/or tasks of the machine learning model that the ambiguities are related to.

As used herein, the term “task-based agent” refers to a component of a machine learning model that is configurable to perform a particular task with respect to an overall functionality of the machine learning model. In one or more examples, the task-based agents are representative of downstream modules of the machine learning model that the machine learning model leverages to generate a response to the query.

As used herein, the term “ambiguity” refers to an instance in which a meaning, intent, and/or scope of a query (either in part or in whole) is unclear and/or is subject to multiple interpretations. In one or more examples, the ambiguity is a task-based ambiguity detected by a task-based agent and accordingly is particular to a particular task associated with the task-based agent.

As used herein, the term “clarification” refers to digital content that is output to elicit additional information to resolve one or more ambiguities in the query. In various examples, the clarification includes one or more of a question, selectable indicia, multiple choice options, dropdown/selectable list, binary confirmation, supplemental digital content, etc. In various examples, the clarification includes one or more of an explanation of the one or more ambiguities, a request for additional information, suggested interpretations of the query, etc.

As used herein, the term “machine learning model” refers to one or more computational systems, models, and/or algorithms to analyze data, identify patterns, and/or perform a variety of inferencing functionality. In various examples, the machine learning model is representative of a large language model (“LLM”) that is configured to comprehend, analyze, and/or generate human-like text. The LLM, for instance, is trained using one or more datasets via supervised learning, semi-supervised learning, unsupervised learning, and/or reinforcement learning to perform one or more natural language processing tasks. In various examples, the LLM is fine-tuned for a particular domain using a refined dataset to understand text-strings and/or contextual information particular to the particular domain.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

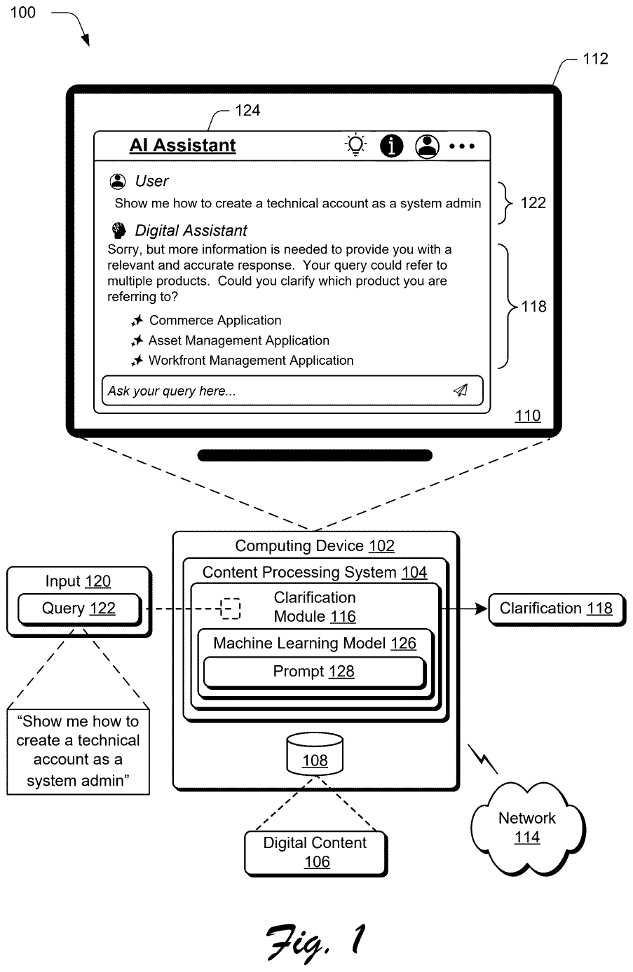

FIG. 1 is an illustration of a digital medium environment 100 in an example implementation that is operable to employ the task-based ambiguity clarification techniques described herein. The illustrated digital medium environment 100 includes a computing device 102, which is configurable in a variety of ways.

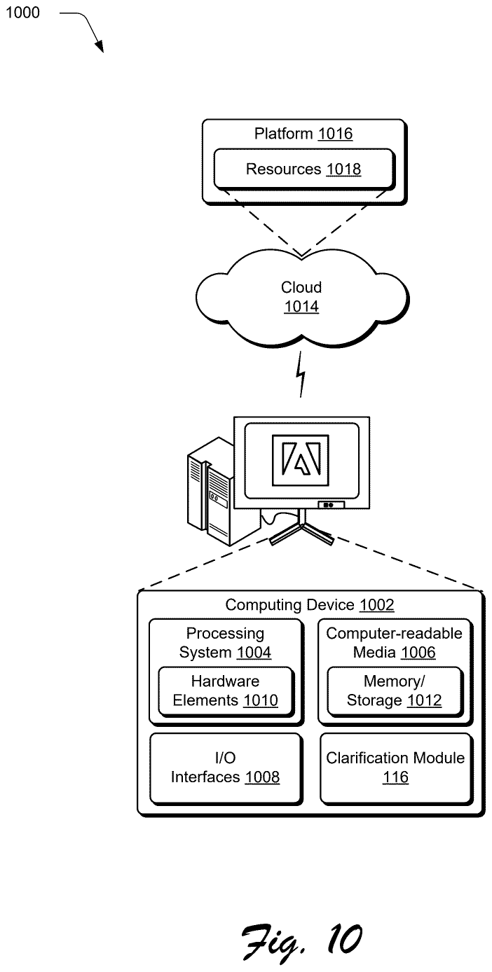

The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 10.

The computing device 102 is illustrated as including a content processing system 104. The content processing system 104 is implemented at least partially in hardware of the computing device 102 to process and transform digital content 106, which is illustrated as maintained in storage 108 of the computing device 102. Such processing includes receipt of the digital content 106, creation of the digital content 106, modification of the digital content 106, analysis of the digital content, and rendering of the digital content 106 in a user interface 110 for output, e.g., by a display device 112. Although illustrated as implemented locally at the computing device 102, functionality of the content processing system 104 is also configurable in whole or in part via functionality available via the network 114, such as part of a web service or “in the cloud.”

An example of functionality incorporated by the content processing system 104 to process the digital content 106 is illustrated as a clarification module 116. The clarification module 116 is configured to determine whether to generate a clarification 118 based on an input 120 that includes a query 122. In the illustrated example, for instance, the query 122 is representative of a user query to a digital assistant 124, e.g., an artificial intelligence-based digital assistant. The clarification 118, for instance, represents digital content 106 output by the clarification module 116, e.g., in the user interface 110, to resolve one or more ambiguities in the query 122.

In the example, the digital assistant 124 is a software component designed to receive input 120 such as requests and/or commands and provide assistance and/or perform tasks based on the input 120. The digital assistant 124, for instance, is an artificial intelligence-based program designed to understand and respond to user queries and/or commands, such as within the user interface 110. The digital assistant 124, for instance, is tailored for one or more domain-specific applications. For instance, in the illustrated example the digital assistant 124 is integrated as part of a comprehensive customer data platform application and thus is configured for a customer data platform domain.

In various examples, the digital assistant 124 leverages one or more machine learning models 126, such as a large language model (“LLM”), and/or one or more natural language processing techniques. A variety of machine learning models 126, training processes, and/or model architectures are considered. In various examples, the machine learning model 126 is configured using one or more of deep learning, supervised learning, semi-supervised learning, unsupervised learning, and/or reinforcement learning.

In one or more examples, the machine learning model 126 is trained using various techniques that include but are not limited to minimization of a loss function, adjustment of one or more weights and/or parameters of the machine learning model 126, one or more backpropagation and/or optimization techniques, etc. In various implementations, the machine learning model 126 includes but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, one or more diffusion models, etc.

In various implementations, the machine learning model 126 is representative of a large language model (“LLM”) that is configured to comprehend, analyze, and/or generate human-like text. The LLM, for instance, is trained on a dataset to perform one or more natural language processing tasks such as text generation, translation, summarization, question-answering, etc. In one or more examples, the LLM is fine-tuned for a particular domain, such as being trained on a refined dataset to understand text-strings and/or contextual information that pertain to the particular domain. In this way, the LLM is fine-tuned to handle domain related queries to generate relevant responses for specialized applications. In the illustrated example, the LLM is fine-tuned for the customer data platform domain.

Additionally, the clarification module 116 and/or the machine learning model 126 are configured to leverage various task-based (e.g., task-specific) agents that each perform respective tasks as part of the collective functionality of the machine learning model 126. The task-based agents, for instance, are configured for particular domain-related functionality, such as to identify domain-specific terminology, to identify entities included in the query 122 that are recognized in a database associated with the domain, and/or to identify one or more assets/products/applications associated with the domain that the query 122 pertains to. This is by way of example, and a variety of task-based agents are contemplated, as further described below.

The query 122 represents a question and/or command provided to the digital assistant 124 and/or to the machine learning model 126. The query 122, for instance, is a natural language request for information, task execution, search functionality, personalization, etc. such as to be performed by the machine learning model 126. In the illustrated example, the query 122 includes a user request for information from the digital assistant 124. For instance, the query 122 includes the text string “show me how to create a technical account as a system admin.”

The clarification module 116 receives the query 122 as input and determines whether or not to generate a clarification 118. For instance, the clarification module 116 is configured to detect whether the query 122 includes one or more task-based ambiguities, such as by leveraging the one or more task-based agents. In the illustrated example, the query 122 is ambiguous in that is does not refer to a particular application, and thus could refer to several different applications within the particular domain.

Based on the one or more task-based ambiguities and the query 122, the clarification module 116 configures a prompt 128 for input to the machine learning model 126. The prompt 128, for instance, is a structured input to guide the machine learning model 126 to determine whether to generate a clarification 118, e.g., whether the query 122 is ambiguous and a clarification 118 is needed to resolve one or more ambiguities present in the query 122. In various examples, the prompt 128 includes one or more portions and/or properties of the query 122, types of ambiguities detected by the clarification module 116, and/or tasks of the machine learning model 126 that the ambiguities are related to.

Based on the prompt 128, the machine learning model 126 determines whether to generate a clarification 118 to resolve the ambiguities. In an example in which the machine learning model 126 determines not to generate a clarification 118, the machine learning model 126 proceeds to generate a response to the query 122. For instance, the content processing system 104 generates an additional prompt for the machine learning model 126 to generate the response to the query.

Additionally or alternatively, the machine learning model 126 generates the clarification 118 based on the prompt 128 to resolve the one or more ambiguities. This overcomes the limitations of conventional techniques that are unable to generate a determination of whether to generate a clarification 118 and to generate the clarification 118 in a single call of the machine learning model 126, such as based on a single prompt, e.g., the prompt 128. The clarification 118 is configurable in a variety of ways and/or formats, such as one or more questions, selectable indicia, confirmation statements, input fields, etc.

In the illustrated example, the clarification module 116 generates the clarification 118 for output in the user interface 110 that includes an explanation of the one or more ambiguities, as well as selectable indicia to resolve the ambiguity. For instance, the clarification module 116 generates the clarification 118 to indicate the query 122 could refer to multiple products. The clarification 118 further includes selectable indicia, such as to select one of the products that the query 122 refers to.

The clarification module 116 is further operable to receive a user response to the clarification 118 and generate an answer to the query 122 based on the query 122 as well as the user response. For instance, the content processing system 104 generates an additional prompt based on the query 122 and the user response for processing by the machine learning model 126 to generate the response to the query 122. In this way, the techniques described herein enhance a user experience while conserving computational resources when resolving ambiguous user queries. Further discussion of these and other advantages is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Task-Based Ambiguity Clarification

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference will be made to FIGS. 1-9.

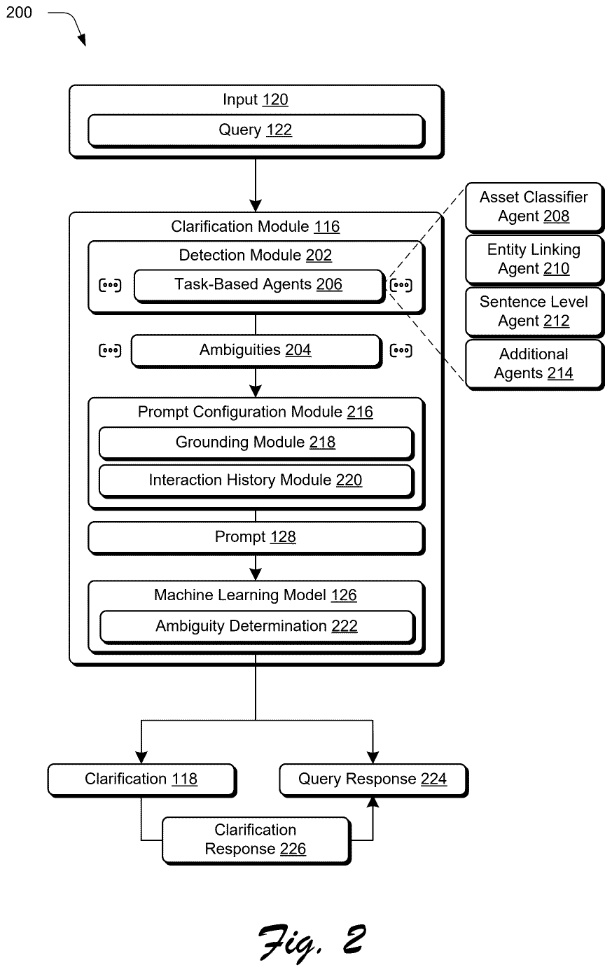

FIG. 2 depicts a system 200 in an example implementation showing operation of a clarification module 116 of FIG. 1 in greater detail. Generally, the clarification module 116 is operable to generate an ambiguity decision, e.g., whether or not to generate a clarification 118, based on a query 122. The clarification module 116 is further operable to generate the clarification 118 based on the query 122, such as in a single call of the machine learning model 126 as further described below.

In an example, the clarification module 116 receives an input 120 that includes a query 122. As described above, the query 122 represents a question and/or command, such as a question and/or a command provided to a digital assistant 124. The query 122, for instance, is a natural language request for information, task execution, search functionality, personalization, etc. such as from a user. In various examples the digital assistant 124 is representative of an artificial intelligence-based digital assistant within a particular domain, e.g., healthcare, finance, banking, retail/e-commerce, education, customer service, digital content creation, computer science, transportation, data management/analytics, etc.

The clarification module 116 includes a detection module 202 that is operable to detect one or more ambiguities 204 within the query 122. An ambiguity 204, for instance, represents an instance in which a meaning, intent, and/or scope of the query 122, either partially or wholly, is unclear and/or is subject to multiple interpretations. Ambiguities 204 thus hinder an ability of the machine learning model 126 to generate an accurate response to the query 122.

A variety of different types of ambiguities 204 are considered, such as lexical ambiguities in which one or more words in the query 122 have multiple interpretations, contextual ambiguities in which external information to provide context to the query 122 is absent, syntactic ambiguities in which a structure of the query 122 permits multiple interpretations, aleatoric ambiguities in which a token included in the query 122 is undefined and/or is interpretable in more than one way, etc. In one or more examples, the ambiguities 204 pertain to domain-specific features of the query 122, as further described in more detail below.

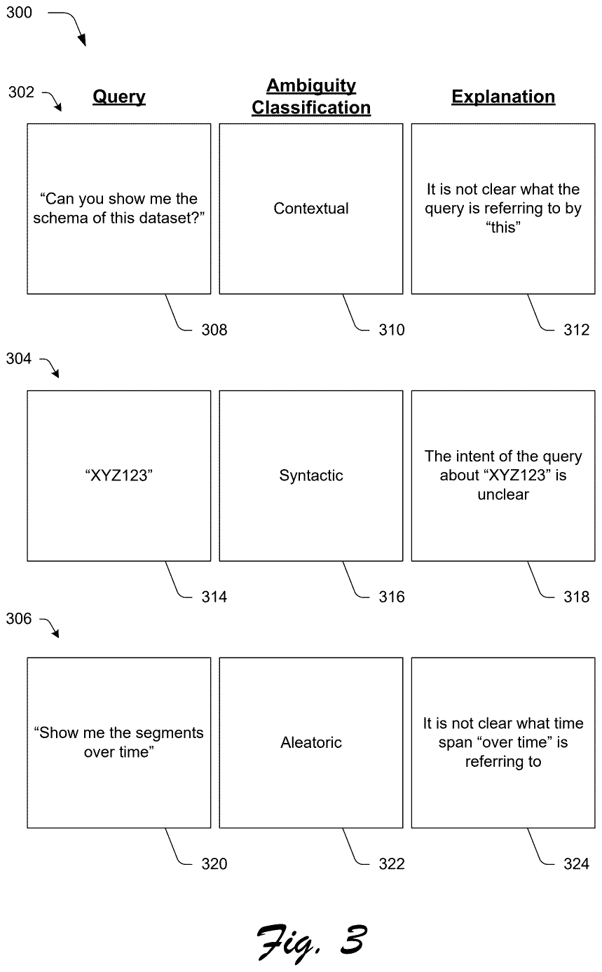

By way of example, FIG. 3 depicts an example 300 of a variety of types of ambiguities present in queries in a first example 302, a second example 304, and a third example 306. As depicted in the first example 302, a first query 308 includes a text string “Can you show me the schema of this dataset.” The first query 308 includes a contextual ambiguity classification 310, that indicates that a context and/or reference to an object in the first query 308 is underspecified. For instance, as depicted by a first explanation 312, the ambiguity derives from under-specification of the word “this,” as it is interpretable in a variety of ways.

As depicted in the second example 304, a second query 314 includes a text string “XYZ123.” The second query 314 includes a syntactic ambiguity classification 316, that indicates that the second query 314 includes an incomplete and/or malformed sentence. For instance, as depicted by a second explanation 318, a user intent associated with the second query 314 is unclear.

As depicted in the third example 306, a third query 320 includes a text string “Show me the segments over time.” The third query 320 includes an aleatoric ambiguity classification 322, that indicates that one or more tokens included in the third query 320 are undefined. For instance, as depicted by a third explanation 324 in the illustrated example, it is unclear what time span “over time” refers to.

Due to the variety of types and extent of ambiguities, conventional approaches, such as those that treat ambiguity as a mere lexical problem, often fail to detect ambiguities and generate off-target and/or inaccurate responses that do not align with a user intent. Additionally or alternatively, conventional approaches that fail to incorporate domain specific information generate unnecessary, generic, and/or ineffectual clarification questions which is computationally inefficient and degrades a user experience.

To overcome these limitations, the detection module 202 leverages one or more task-based agents 206 to detect the ambiguities 204, e.g., task-based ambiguities, that relate to discrete tasks of the machine learning model 126. For instance, the one or more task-based agents 206 are each configured to perform a particular task, such as tasks related to operation of the machine learning model 126. For instance, the task-based agents 206 are representative of downstream modules of the machine learning model 126 that the machine learning model 126 leverages to generate a response to the query 122.

Accordingly, a task-based ambiguity 204 pertains to a particular task of a particular task-based agent 206. In various examples, a task-based agent 206 is configured to incorporate and/or consider various domain specific information, e.g., domain-specific definitions, enterprise knowledge graphs, classifiers, databases, etc. In this way, the detection module 202 is operable to detect, understand, and resolve domain-specific ambiguities 204 within the query 122 particular to individual machine learning tasks which is not possible using conventional techniques.

A variety of tasks, task-based agents 206, and task-based ambiguities 204 are considered. In one or more examples, the task-based agents 206 include an asset classifier agent 208. The asset classifier agent 208, for instance, is configured for an asset detection task and as such is operable to determine whether the query 122 pertains to a particular asset within a particular domain. The assets, for instance, include one or more of a particular product, service, application, platform, tool, etc.

In various examples, the asset classifier agent 208 detects a string included in the query 122 that mentions a particular asset, e.g., the query 122 directly mentions the particular asset. Additionally or alternatively, the asset classifier agent 208 infers that the query 122 pertains to a particular asset based on one or more contextual indicators of the query 122, semantic properties of the query 122, keyword analysis of the query 122, etc. For example, the query 122 does not directly mention a particular asset however the asset classifier agent 208 is able to determine that the query 122 pertains to the particular asset based on a contextual analysis of the query 122.

The detection module 202 is configured to leverage the asset classifier agent 208 to detect ambiguities 204 related to the asset detection task. Consider an example in which a query 122 includes a string “how do I log out?” The detection module 202 leverages the asset classifier agent 208 to determine that the query 122 is indeterminate and pertains to two or more assets within a particular domain. For instance, the query 122 relates to multiple products and each product is associated with a different log out procedure. Accordingly, the detection module 202 detects an ambiguity 204 related to the asset detection task.

In an additional or alternative example, the task-based agents 206 include an entity linking agent 210. The entity linking agent 210, for instance, is configured for an entity linking task. The entity linking task includes mapping (e.g., correlating) one or more strings included in the query 122 to entities stored in a database, e.g., the storage 108. In an example, an entity is representative of a domain-specific value, data structure, and/or identifier stored in a domain-specific database.

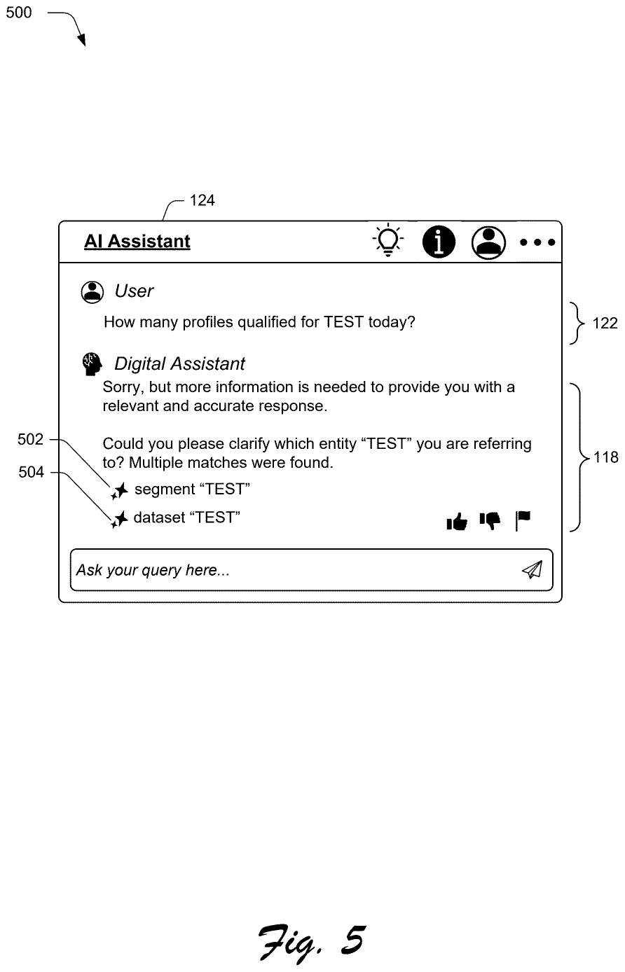

Accordingly, the detection module 202 is configured to leverage the entity linking agent 210 to detect ambiguities 204 related to the entity linking task, e.g., entity linking ambiguities. In an example, the query 122 includes a domain specific term and/or string such as “e-mail.” The entity linking agent 210 determines that the term maps to (e.g., is associated with) more than one entity in the database. In this way, the detection module 202 detects an ambiguity 204 particular to the entity linking task. This functionality is further described below with respect to FIG. 5.

Additionally or alternatively, the task-based agents 206 include a sentence level agent 212. The sentence level agent 212, for instance, is configured to detect various semantic properties (e.g., a language style of the query, presence of keywords or text strings in the query, sentiment analysis information, task classification information, spelling and/or grammar, etc.) of the query 122. Accordingly, the detection module 202 is operable to leverage the sentence level agent 212 to detect ambiguities 204 present in the query 122 on a sentence level. In one example, the sentence level agent 212 is a binary classifier that includes a machine learning model to determine whether the query 122 includes an ambiguity 204, e.g., a lexical ambiguity. In one or more examples, the sentence level agent 212 is domain agnostic such that the detection module 202 is able to detect ambiguities 204 within the query 122 across multiple domains.

In various examples, the task-based agents 206 include one or more additional agents 214. For instance, the asset classifier agent 208, the entity linking agent 210, and the sentence level agent 212 are provided by way of example and not limitation. In various examples, the task-based agents 206 leveraged by the detection module 202 are modular, such that the task-based agents 206 are customizable based on a particular application and/or domain. In this way, the techniques described herein are extensible for a variety of applications and/or uses.

The clarification module 116 further includes a prompt configuration module 216 that is configured to generate a prompt 128 for processing by the machine learning model 126. As described in more detail above, the prompt 128 is a structured input to guide the machine learning model 126 to determine whether to generate a clarification 118 to resolve ambiguities 204 present in the query 122. In an example, the prompt 128 represents an internal input provided to the machine learning model 126 and thus is not visible to a user. In various examples, the prompt 128 is based on the query 122 as well the one or more ambiguities 204.

For example, the prompt configuration module 216 includes, refines, edits, removes content from and/or supplements content included in the query 122 as part of generation of the prompt 128. The prompt configuration module 216 further generates the prompt 128 to include the ambiguities 204. For instance, the prompt configuration module 216 incorporates output from one or more of the task-based agents 206 into the prompt 128.

In various implementations, the prompt configuration module 216 generates the prompt 128 to include a description of one or more of the task-based agents 206 and whether or not one or more of the task-based agents 206 identified respective task-based ambiguities 204. For instance, for each of the task-based agents 206 that identified a respective ambiguity 204, the prompt configuration module 216 includes a description of the task-based agent 206 and a description of the corresponding ambiguity 204 in the prompt 128. In one or more examples, the description of the ambiguity 204 includes one or more of a type of ambiguity 204, a task that the ambiguity 204 is related to, a cause of the ambiguity 204, a context of the ambiguity 204, and/or possible interpretations of the ambiguity 204.

By way of example, consider that the entity linking agent 210 identifies an ambiguity 204 related to an entity linking task as described above. The prompt configuration module 216 configures the prompt 128 to include a description of the entity linking agent 210, e.g., “Agent Description: entity linking agent serves a function of associating and/or connecting mentions of entities to corresponding entities in a database.” The prompt 128 is further configured to include that the entity linking agent 210 detected an ambiguity 204, e.g., “Ambiguity Detected: TRUE.” The prompt 128 further includes potential interpretations of the ambiguity 204 such as entities in the database that map to a term in the query 122, e.g., “Matches: ENT is linked to ENT_1, ENT_2, and/or ENT_3” where ENT is a string included in the query 122 and ENT_1, ENT_2, and ENT_3 are entities included in the database that ENT is associated with. The prompt configuration module 216 repeats this process to represent each ambiguity 204 detected by the detection module 202 in the prompt 128.

The prompt configuration module 216 further includes a grounding module 218 that is operable to include grounding information in the prompt 128. In various implementations, grounding information includes contextual data that is configurable to assist the machine learning model 126 to understand and/or interpret the query 122 in a context of a particular domain. For instance, the grounding information includes one or more keywords and/or strings, domain-specific instructions, and/or definitions of domain-specific terms.

By way of example, a query 122 includes a word “segment.” The grounding module 218 identifies the term as a domain-specific term and includes a definition of “segment” in the prompt 128. Through inclusion of domain-specific grounding information in the prompt 128, the techniques described herein augment an ability of the machine learning model 126 to comprehend the query 122, and thus resolve potential ambiguities and reduce an incidence of unnecessary generation of clarification questions, which further conserves computational resources. The grounding information is further beneficial for the machine learning model 126 to generate contextually relevant clarifications 118, as further described in more detail below.

In various examples, the prompt configuration module 216 further includes an interaction history module 220 that is operable to include historical interaction data in the prompt 128. The historical interaction data, for instance, includes a conversation history between a user and a digital assistant 124, e.g., one or more previous queries provided by the user and/or one or more responses provided by the digital assistant 124. Accordingly, the interaction history module 220 is operable to edit, remove content from, and/or supplement content included in the query 122 based on one or more previous queries received by the clarification module 116 as part of generation of the prompt 128.

By way of example, a query 122 includes text “display it for me,” which would otherwise be identified as ambiguous. The interaction history module 220 accesses a previous query that includes text “what is the segment.” Based on the previous query, the interaction history module 220 modifies the query 122 for inclusion in the prompt 128 as “display the segment for me.” In this way, the interaction history module 220 is able to derive contextual information from historical interaction data to resolve potential ambiguities and prevent unnecessary clarification question generation.

In various examples, the prompt configuration module 216 configures the prompt 128 to indicate that no ambiguities were detected with respect to one or more tasks. Additionally or alternatively, the prompt configuration module 216 configures the prompt 128 to apply a weighting to one or more of the ambiguities 204. For example, a particular task of a particular task-based agent 206 is more dispositive as to whether a clarification 118 will be needed relative to other tasks of other task based agents 206. Accordingly, the prompt configuration module 216 is configured to apply a weighting to a determination generated by the particular task-based agent 206, such that if an ambiguity 204 associated with the particular task-based agent 206 is detected, a clarification 118 is likely to be needed.

In various examples, the prompt 128 is further configured to include instructions for the machine learning model 126, such as to determine whether to generate a clarification 118 and/or to generate the clarification 118. For instance, the machine learning model 126 receives the prompt 128 as input and generates an ambiguity determination 222 by processing the prompt 128. As described above, a variety of machine learning model architectures, training modalities, and/or parameterizations are considered. In one or more examples, the machine learning model 126 is an LLM configured to comprehend, analyze, and/or generate human-like text. In an example, the ambiguity determination 222 represents a determination of whether or not the query 122 is ambiguous as a whole, e.g., whether the machine learning model 126 is able to effectively generate a response to the query 122. Accordingly, the ambiguity determination 222 indicates whether or not to generate a clarification 118.

In various examples, the ambiguity determination 222 is a binary determination, e.g., the query 122 is ambiguous or the query 122 is not ambiguous. In at least one example, the ambiguity determination 222 is based on a probability metric (e.g., a confidence score, likelihood percentage, certainty level, etc.) output by the machine learning model 126 that indicates a probability that the query 122 is ambiguous. Accordingly, the clarification module 116 is operable to determine that the probability metric is above a threshold to generate the ambiguity determination 222. For example, the ambiguity determination 222 indicates that the query 122 has a 95% likelihood of ambiguity, and thus a clarification 118 is recommended.

In an example, the ambiguity determination 222 indicates not to generate a clarification 118, e.g., that the query 122 is not ambiguous. Accordingly, the machine learning model 126 generates a query response 224 that provides an answer to the query 122. In one or more examples, an additional prompt is generated for input to the machine learning model 126 to generate the query response 224. The additional prompt, for instance, is based on the query 122 and includes an instruction to answer the query 122.

In at least one example, the clarification module 116 detects one or more ambiguities 204, however determines based on processing of the prompt 128 that as a whole the query 122 is not ambiguous, e.g., that the machine learning model 126 is able to generate an accurate response to the query 122 regardless of the one or more ambiguities 204. For instance, the machine learning model 126 is able to resolve the one or more ambiguities 204 based on the grounding information and/or the historical interaction data included in the prompt 128. Accordingly, in this example the machine learning model 126 proceeds to generate a query response 224 without generation of a clarification 118.

Additionally or alternatively, the ambiguity determination 222 indicates to generate a clarification 118, e.g., the ambiguity determination 222 indicates that the query 122 as a whole is ambiguous. Generally, the clarification 118 is representative of digital content 106 that is configured to elicit additional information to resolve the one or more ambiguities 204 included in the query 122. The clarification 118, for instance, is a request that is output in a user interface 110 to clarify one or more aspects of the query 122.

The machine learning model 126 generates the clarification 118 based on the prompt 128. The prompt 128, for instance, is a multitask prompt that includes instructions for the machine learning model 126 to generate the ambiguity determination 222 and the clarification 118. Accordingly, a single call (e.g., pass) of the machine learning model 126 is effective to generate both the ambiguity determination 222 as well as the clarification 118. A call, for instance, refers to an instance of executing the machine learning model 126 by providing the prompt 128 as input and obtaining a model output such as by passing the prompt 128 through layers of the machine learning model 126 in a forward pass. Accordingly, the techniques described herein conserve computational resources relative to conventional approaches that are reliant on multiple calls of models.

Further, because the prompt 128 includes domain-specific information, such as derived from one or more of the task-based agents 206, one or more task-based ambiguities 204, the grounding information obtained by the grounding module 218, and/or the interaction history data obtained by the interaction history module 220, the machine learning model 126 is able to generate a domain-specific clarification 118 that directly addresses particular types of ambiguities. For instance, the clarification 118 references one or more particular tasks that the ambiguity 204 arises from using domain-specific terminology. In this way, the techniques described herein are able to generate effective clarifications 118 that improve an accuracy of the machine learning model 126 relative to conventional approaches.

The clarification 118 is configurable in a variety of ways. For instance, the clarification module 116 configures the clarification 118 to include one or more of a direct question, selectable indicia, multiple choice options, dropdown/selectable list, binary confirmation (e.g., “Yes” or “No”), supplemental digital content, etc. Further, in various examples the clarification 118 includes one or more of an explanation of the one or more ambiguities 204, a request for additional information, a description of one or more of the task-based agents 206 such as those that detected an ambiguity 204, suggested interpretations of the query 122, etc.

In an example, the clarification module 116 configures the clarification 118 as a direct question. For instance, the clarification module 116 receives a query 122 that includes text “confirm if data is currently being ingested.” The clarification module 116 identifies one or more ambiguities 204 within the query 122 and in accordance with the techniques described herein generates the clarification 118 as a question that includes text “Could you please specify which data you are referring to and where it is being ingested?”

In an additional or alternative example, the clarification module 116 generates the clarification 118 to include one or more selectable indicia. The selectable indicia, for instance, a configured by the clarification module 116 such that selection of one or more of the selectable indicia resolves an ambiguity 204. For example, responsive to a query 122 that includes text “show me how to create an account” the clarification module 116 generates the clarification 118 to include text “Your query could refer to multiple applications, please identify which application you are referring to.” The clarification 118 in this example further includes several selectable indicia, such as to select “Application A,” “Application B,” or “Application C”.

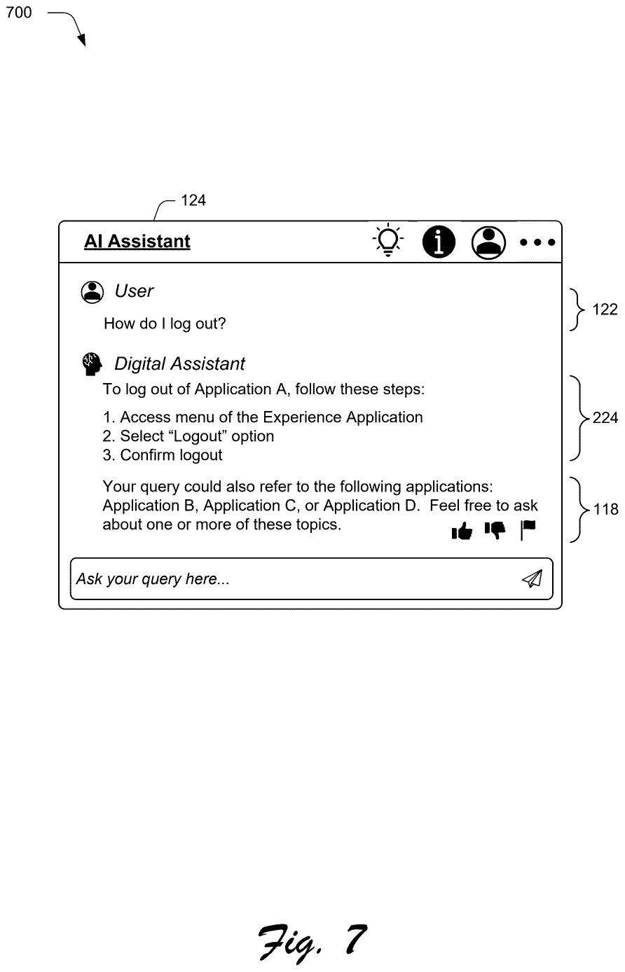

In at least one example, the clarification module 116 generates a response to the query 122, e.g., a query response 224, and appends the clarification 118 to the query response 224. For instance, the prompt 128 is configured to instruct the machine learning model 126 to make a “best guess” as to a user's intent and append the clarification 118 to the query response 224 to resolve potential ambiguities 204. Accordingly, the techniques described herein provide customizable surfacing options to enhance a user experience, such as further described below with respect to FIG. 7.

The clarification module 116 is further operable to receive a clarification response 226, e.g., an additional input that includes a response to the clarification 118. For instance, the clarification response 226 is received as user input to the user interface 110. Based on one or more of the query 122, the clarification 118, and/or the clarification response 226, the machine learning model 126 is operable to generate a query response 224. In one or more examples, an additional prompt is generated for input to the machine learning model 126 to generate the query response 224. The additional prompt, for instance, is based on the query 122 as well as the query response 224 and includes an instruction for the machine learning model 126 to answer the query 122. In this way, the techniques described herein provide an efficient and accurate approach to resolve a variety of ambiguities 204 in queries 122.

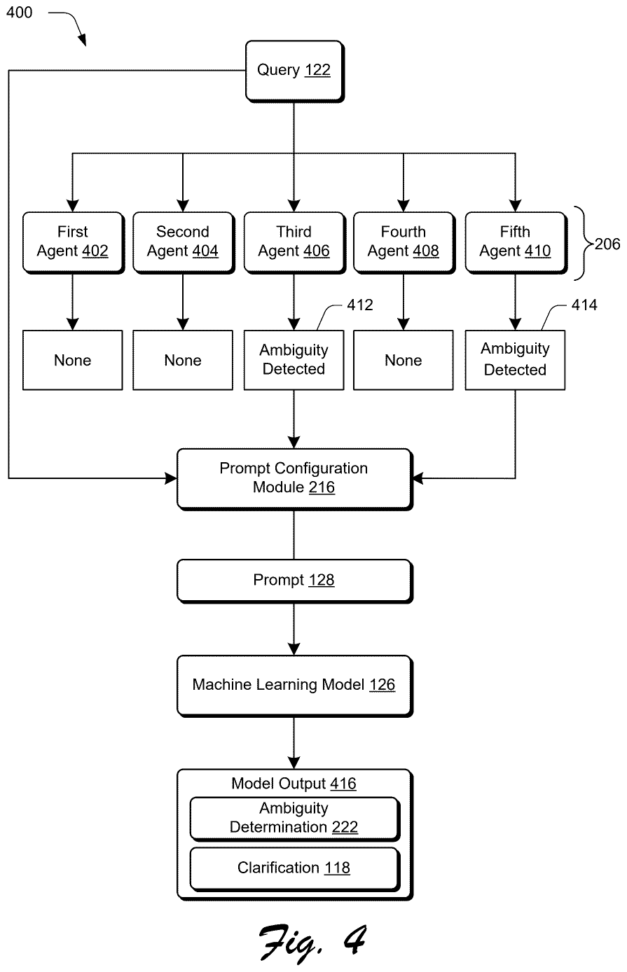

FIG. 4 depicts an example 400 of task-based ambiguity clarification in which a model output is generated based on a query. In this example, the clarification module 116 receives a query 122, such as a query 122 provided in a user interface 110 to a digital assistant 124. The clarification module 116 includes several task-based agents 206 to detect a variety of task-based ambiguities 204. In the illustrated example, the task-based agents 206 include a first agent 402 that is configured for a first task, a second agent 404 configured for a second task, a third agent 406 configured for a third task, a fourth agent 408 configured for a fourth task, and a fifth agent 410 configured for a fifth task.

In accordance with the techniques described above, the clarification module 116 leverages the task-based agents 206 to detect task-based ambiguities 204 with respect to each of the task-based agents 206, e.g., ambiguities 204 with respect to the first task, second task, third task, fourth task, and fifth task. As depicted in the illustrated example, the third agent 406 detects a first ambiguity 412 with respect to the third task. Further, the fifth agent 410 detects a second ambiguity 414 with respect to the fifth task. The query 122 in this example is not ambiguous with respect to the first task, second task, and fourth task.

Accordingly, the prompt configuration module 216 generates a prompt 128 for processing by the machine learning model 126. The prompt 128 is based on the query 122, the first ambiguity 412, and the second ambiguity 414. For instance, the prompt includes text from the query 122, a description of the third agent 406, a description of the first ambiguity 412, a description of the fifth agent 410, and a description of the second ambiguity 414. The prompt configuration module 216 further configures the prompt 128 to include instructions for the machine learning model 126 to generate an ambiguity determination 222 as well as to generate a clarification 118 based on the ambiguity determination 222.

Based on the prompt 128, the machine learning model 126 generates a model output 416. In this example the model output 416 includes the ambiguity determination 222 which indicates that the query 122 is ambiguous and thus a clarification 118 is recommended. The model output 416 further includes the clarification 118. The clarification 118, for instance, is configured to resolve both the first ambiguity 412 as well as the second ambiguity 414. Further, the clarification 118 references both the third agent 406 and the fifth agent 410 such as to provide additional context within the clarification 118.

Because the ambiguity determination 222 and the clarification 118 are both based on the prompt 128, the techniques described herein capture an interdependence between various types of ambiguities and generation of the clarification 118, such that the clarification 118 is generated based on the one or more ambiguities 204. Further, because the clarification module 116 generates both the ambiguity determination 222 and the clarification 118 with a single call to the machine learning model 126 (e.g., a single inference operation) the techniques described herein conserve computational resources relative to conventional ambiguity resolution techniques that rely on multiple calls to machine learning models.

FIG. 5 depicts an example 500 of task-based ambiguity clarification in which a clarification question is generated based on a query. In this example, the clarification module 116 receives a query 122, such as provided to a digital assistant 124 within a user interface 110. In this example, the digital assistant 124 is tailored for a domain-specific application such as a part of a comprehensive customer data platform.

In accordance with the techniques described herein, the clarification module 116 determines whether the query 122 includes one or more ambiguities 204. For instance, the clarification module 116 leverages the entity linking agent 210 to determine that the query 122 includes a domain-specific term “TEST” and that the term “TEST” maps (e.g., corresponds) to multiple entities in a database. Accordingly, the clarification module 116 determines that the query 122 includes an ambiguity 204 with respect to an entity linking task.

The clarification module 116 configures a prompt 128 for processing by the machine learning model 126. The prompt 128, for instance, is based on the query 122 and the entity linking task ambiguity 204. The machine learning model 126 outputs a result of the processing of the prompt 128, which in this example includes a determination that the query 122 is ambiguous and thus a clarification 118 is recommended. The model output further includes the clarification 118.

As depicted in the illustrated example, the clarification 118 is tailored to the particular type of ambiguity 204 detected in the query 122, e.g., the entity linking task ambiguity 204. For instance, the clarification 118 includes a description of the ambiguity 204, e.g., that multiple matches for the term “TEST” were found. The clarification 118 further includes a first selectable indicia 502 and a second selectable indicia 504 that include suggested resolutions to the ambiguity 204. The first selectable indicia 502 and the second selectable indicia 504, for instance, are clickable buttons that are selectable to resolve the ambiguity 204. In this way, a user is able to clarify which “TEST” the user is referring to in the query 122. Based on the query 122 and the user selection of the first selectable indicia 502 or the second selectable indicia 504, the machine learning model 126 is configured to generate a response to the query 122.

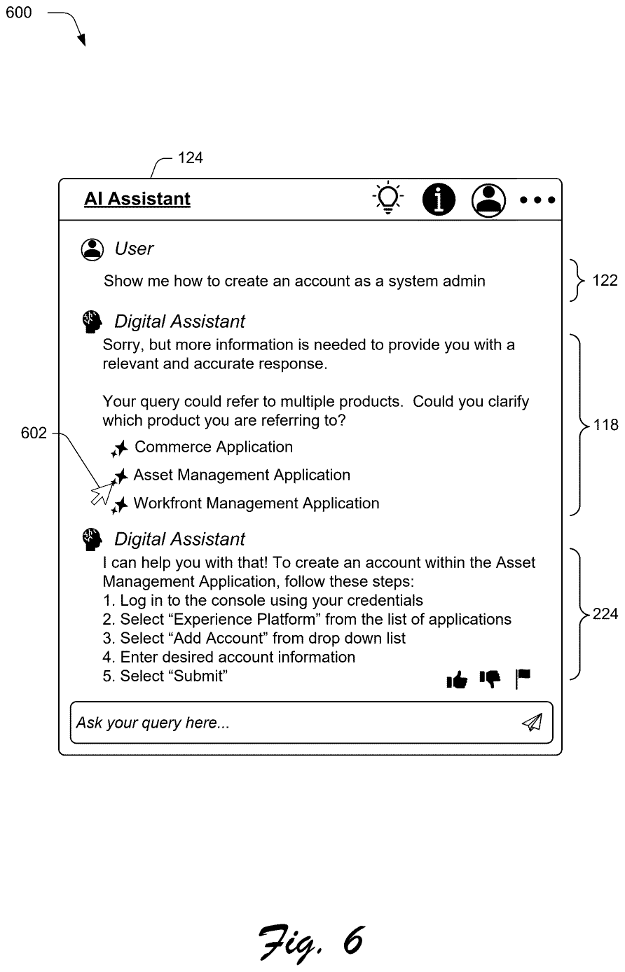

FIG. 6 depicts an example 600 of task-based ambiguity clarification in which a response to a query is generated based on the query and a response to a clarification question. In this example, the clarification module 116 receives a query 122, such as provided to a digital assistant 124 within a user interface 110. In this example, the digital assistant 124 is tailored for a domain-specific application such as a comprehensive customer data platform domain.

In accordance with the techniques described herein, the clarification module 116 determines whether the query 122 includes one or more ambiguities 204. For instance, the clarification module 116 leverages the asset classifier agent 208 to determine that the query 122 pertains to multiple assets, e.g., multiple products within the domain. Accordingly, the clarification module 116 determines that the query 122 includes an ambiguity 204 with respect to an asset classification task.

The clarification module 116 configures a prompt 128 for processing by the machine learning model 126. The prompt 128, for instance, is based on the query 122 and the asset classification task ambiguity 204. The machine learning model 126 outputs a result of the processing of the prompt 128, which in this example includes an ambiguity determination 222 and a clarification 118.

As depicted in the illustrated example, the clarification 118 is tailored to the particular type of ambiguity 204 detected in the query 122, e.g., the asset classification task ambiguity 204. For instance, the clarification 118 includes a description of the ambiguity 204, e.g., that the query 122 pertains to multiple products. The clarification 118 further includes several selectable indicia associated with different products to resolve the ambiguity 204.

In this example, the clarification module 116 receives a clarification response 226, e.g., a user input 602 to select the Asset Management Application. The machine learning model 126 then generates a query response 224 based on the query 122 as well as the clarification response 226. As depicted in the illustrated example, the query response 224 answers the query 122 and is tailored to the asset management application as specified by the clarification response 226. In this way, the techniques described herein enhance a user experience to resolve ambiguity in user queries in a computationally efficient manner.

FIG. 7 depicts an example 700 of task-based ambiguity clarification in which a clarification question is provided supplemental to a query response. In this example, the clarification module 116 receives a query 122 provided via user interaction with a digital assistant 124 in a user interface 110. In accordance with the techniques described above, the clarification module 116 generates a prompt 128 for processing by the machine learning model 126 to generate an ambiguity determination 222.

In this example, the ambiguity determination 222 indicates that there is a potential ambiguity. For instance, the ambiguity determination 222 indicates that there is a non-zero chance that the query 122 includes an ambiguity 204, e.g., with respect to what application the query 122 refers to, however proceeds to generate a query response 224 tailored to “Application A”. In at least one example, this is because the clarification module 116 is able to resolve the ambiguity 204, such as by accessing interaction history of the user with the digital assistant 124. In an additional or alternative example, this is because the ambiguity determination 222 includes a probability metric below a threshold that indicates that it is unlikely that the query 122 includes an ambiguity 204, however there is still a non-zero chance that the query 122 includes an ambiguity 204.

Accordingly, the clarification module 116 is operable to supplement the query response 224 with a clarification 118. The clarification 118, for instance, is generated in accordance with the techniques described above. In the illustrated example, the clarification 118 describes the potential ambiguity 204 and includes suggested alternatives to resolve the potential ambiguity 204, such as to ask about Application B, Application C, or Application D. Accordingly, the techniques described herein provide for a variety of user interface functionality to optimize a user experience with a digital assistant 124.

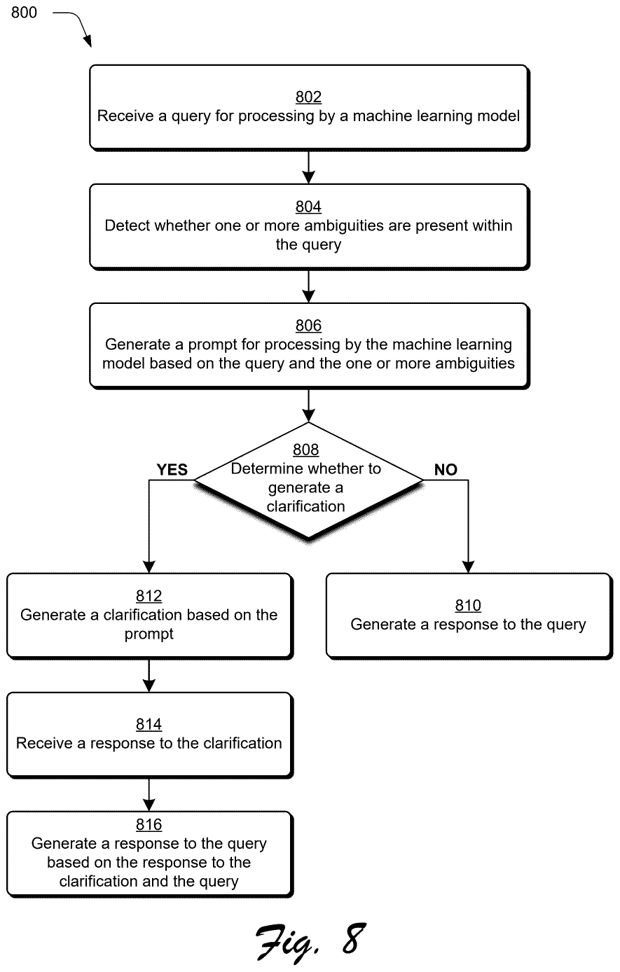

FIG. 8 is a flow diagram depicting an algorithm as a step-by-step procedure 800 in an example implementation that is performable by a processing device to generate clarification questions and responses based on queries.

To begin in this example, a query for processing by a machine learning model is received (block 802). The query 122, for instance, is representative of a user input to a machine learning model 126. In an example, the query 122 includes a natural language request for information, task execution, search functionality, personalization, etc. In one or more examples, the machine learning model 126 is configured for question-answering task and is implemented as a part of a digital assistant 124, e.g., an artificial intelligence-based digital assistant. Accordingly, the query 122 is included as part of a natural language input 120 received by a user interface 110 that includes the digital assistant 124.

It is then detected whether one or more ambiguities are present within the query (block 804). An ambiguity 204, for instance, represents an instance in which a meaning, intent, and/or scope of the query 122, either partially or wholly, is unclear and/or is subject to multiple interpretations. Ambiguities 204 thus hinder an ability of the machine learning model 126 to generate an accurate response to the query 122. A variety of different types of ambiguities 204 are considered, such as lexical ambiguities, contextual ambiguities, syntactic ambiguities, aleatoric ambiguities, etc.

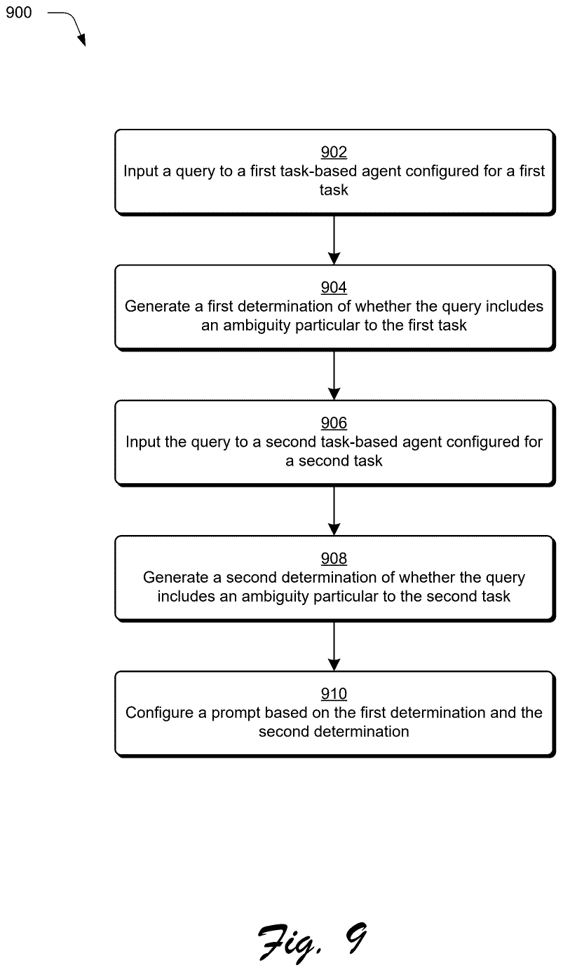

In various examples, the ambiguities 204 are task-based ambiguities, such that the one or more ambiguities 204 are particular to a certain task of the machine learning model 126. For instance, the clarification module 116 leverages one or more task-based agents 206 that are configured for respective tasks, e.g., domain-specific tasks, to detect the one or more ambiguities 204 as further described below with respect to FIG. 9. In this way, the clarification module 116 is operable to detect, understand, and resolve domain-specific ambiguities 204 within the query 122 particular to individual machine learning tasks.

A prompt is generated for processing by the machine learning model (block 806). The prompt 128, for instance, is based on the query 122 and the one or more ambiguities 204 such as the task-based ambiguities. The prompt 128 further includes instructions to guide the machine learning model 126 to generate an ambiguity determination 222 that indicates whether the query 122 is ambiguous. In various examples, the prompt 128 is a multitask prompt, and is further configured to instruct the machine learning model 126 to generate the clarification 118 such as based on the ambiguity determination 222. In this way, the techniques described herein conserve computational resources via generation of an ambiguity determination 222 and a clarification 118 through a single call of the machine learning model 126.

It is then determined whether to generate a clarification based on the ambiguity determination (block 808). For instance, the machine learning model 126 processes the prompt 128 to generate an ambiguity determination 222. In an example, the ambiguity determination 222 represents a determination of whether or not the query 122 is ambiguous as a whole, e.g., whether the machine learning model 126 is able to effectively generate a response to the query 122 without additional information.

In various examples, the ambiguity determination 222 is a binary determination, e.g., the query 122 is ambiguous or the query 122 is not ambiguous. In at least one example, the ambiguity determination 222 is based on a probability metric (e.g., a confidence score, likelihood percentage, certainty level, etc.) output by the machine learning model 126 that indicates a probability that the query 122 is ambiguous. Accordingly, the ambiguity determination 222 indicates whether or not to generate a clarification 118.

In one example, the ambiguity determination 222 indicates that the query 122 is not ambiguous and thus no clarification 118 is needed, e.g., “NO” at block 808. Accordingly, a response to the query is generated (block 810). In at least one example, the clarification module 116 generates an additional prompt for processing by the machine learning model 126 to generate a query response 224. The additional prompt, for instance, includes the query 122 and instructions for the machine learning model 126 to generate the query response 224. The machine learning model 126 is then operable to generate and/or output the query response 224 based on the additional prompt.

In another example, the ambiguity determination 222 indicates that the query 122 is ambiguous and thus a clarification 118 is recommended, e.g., “YES” at block 808. Accordingly, a clarification is generated based on the prompt (block 812). The clarification 118, for instance, represents digital content 106 output by the clarification module 116, e.g., in the user interface 110, to obtain additional information to resolve the one or more ambiguities 204 in the query 122.

In various examples, the clarification 118 includes one or more of a question, selectable indicia, multiple choice options, dropdown/selectable list, binary confirmation (e.g., “Yes” or “No”), supplemental digital content, etc. Further, in various examples the clarification 118 includes one or more of an explanation of the one or more ambiguities 204, a request for additional information, a description of one or more of the task-based agents 206 such as those that detected an ambiguity 204, suggested interpretations of the query 122, etc.

Continuing with this example, a response is received to the clarification (block 814). For instance, a clarification response 226 is received in the user interface 110, such as via user input to respond to a question included in the clarification 118. In an additional or alternative example, the clarification response 226 is received based on an input to select one or more selectable indicia included in the clarification 118.

A response to the query is then generated based on the response to the clarification and the query (block 816). For instance, the machine learning model 126 generates a query response 224 that includes an answer to the query 122 based on the query 122 as well as the clarification response 226. For example, an additional prompt is generated for processing by the machine learning model 126 that is based on the query 122 as well as the query response 224 and further includes a task to answer the query 122. The machine learning model 126 processes the additional prompt to generate the query response 224. In this way, the techniques described herein provide an efficient and accurate approach to resolve a variety of ambiguities 204 present in queries 122.

FIG. 9 is a flow diagram depicting an algorithm as a step-by-step procedure 900 in an example implementation that is performable by a processing device to configure a prompt for processing by a machine learning model. One or more steps of the procedure 900, for example, are implementable as substeps of block 804 and/or block 806 of FIG. 8.

To begin in this example, a query is input to a first task-based agent configured for a first task (block 902). The first task-based agent, for instance, is configured for a particular task as part of operation of the machine learning model 126. A first determination of whether the query includes an ambiguity particular to the first task is generated (block 904). For instance, the clarification module 116 leverages the first task-based agent to generate the first determination.

The query is then input to a second task-based agent configured for a second task (block 906). Similar to the first task-based agent, the second task-based agent is configured for a particular task as part of operation of the machine learning model 126. In various examples, the first task-based agent and/or the second task-based agent are configured for domain specific functionality, such as to identify domain-specific terminology, to identify entities included in the query 122 that are recognized in a database associated with the domain, and/or to identify one or more products/applications that are associated with the domain. Additionally or alternatively, the first task-based agent and/or the second task-based agent are configured for domain agnostic functionality, such as to detect ambiguities 204 within the query 122 across multiple domains.

A second determination of whether the query includes an ambiguity particular to the second task is then generated (block 908). For instance, the clarification module 116 leverages the second task-based agent to generate the second determination.

A prompt is then configured based on the first determination and the second determination (910). The prompt, for instance, includes one or more of the query 122, a description of the first task, a description of the second task, the first determination, and/or the second determination. The clarification module 116 is further operable to leverage one or more additional task-based agents 206 to generate one or more additional determinations. Accordingly, in at least one example the prompt 128 is further based on the one or more additional determinations.

Accordingly, the prompt 128 includes information about the query 122 as well as ambiguity information from multiple tasks. In this way, the machine learning model 126 (via processing of the prompt 128) is able to generate ambiguity determinations 222 with increased accuracy and generate domain and task-based clarifications 118 to resolve various ambiguities 204.

### Example System and Device

FIG. 10 illustrates an example system generally at 1000 that includes an example computing device 1002 that is representative of one or more computing systems and/or devices that implement the various techniques described herein. This is illustrated through inclusion of the clarification module 116. The computing device 1002 is configurable, for example, as a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing system 1004. The instructions and/or functions are executable/operable by one or more articles of manufacture (for example, one or more computing devices 1002 and/or processing systems 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a query for processing by a machine learning model;
detecting, by the processing device, one or more task-based ambiguities within the query using one or more task-based agents configured for respective tasks of the machine learning model;
generating, by the processing device, a prompt for processing by the machine learning model to determine whether to generate a clarification question about the query, the prompt based on the query and the one or more task-based ambiguities; and
outputting, by the processing device, a result of the processing of the prompt.

2. The method as described in claim 1, wherein the prompt is configured to include domain-specific grounding information, the domain-specific grounding information including one or more of a domain-specific keyword, a domain-specific instruction, or a definition of a domain-specific term.

3. The method as described in claim 1, wherein the detecting the one or more task-based ambiguities includes:
inputting the query to a first task-based agent configured for a first task of the machine learning model;
generating, by the first task-based agent, a first determination of whether the query includes a first ambiguity particular to the first task;
inputting the query to a second task-based agent configured for a second task of the machine learning model; and
generating, by the second task-based agent, a second determination of whether the query includes an ambiguity particular to the second task.

4. The method as described in claim 3, wherein the prompt is configured to include a description of the first task, a description of the second task, the first determination, and the second determination.

5. The method as described in claim 1, further comprising generating, by the machine learning model and based on the processing of the prompt, the clarification question for output by the processing device to resolve the one or more task-based ambiguities.

6. The method as described in claim 5, further comprising:
receiving an input that includes a response to the clarification question;
generating an additional prompt for processing by the machine learning model based on the query and the response to the clarification question; and
outputting, based on the processing of the additional prompt by the machine learning model, a response to the query.

7. The method as described in claim 1, further comprising: resolving the one or more task-based ambiguities without generating the clarification question;
and generating a response to the query by the machine learning model.

8. The method as described in claim 1, wherein the one or more task-based ambiguities are detected based on semantic properties of the query.

9. The method as described in claim 1, wherein the one or more task-based ambiguities includes an entity linking ambiguity related to an entity linking task that indicates a string included in the query is associated with two or more entities included in a domain-specific database associated with the machine learning model.

10. A system comprising:
a memory component; and
a processing device coupled to the memory component, the processing device to perform operations including:
receiving a query for processing by a machine learning model;
detecting one or more task-based ambiguities within the query;
generating a multitask prompt for processing by the machine learning model based on the query and the one or more task-based ambiguities, the multitask prompt configured to:
determine whether the query is ambiguous; and
generate a clarification question to resolve the one or more task-based ambiguities; and
outputting, based on a determination that the query is ambiguous and as a result of the processing of the multitask prompt, the clarification question.

11. The system as described in claim 10, wherein the generating the multitask prompt includes:
inputting the query to a first task-based agent configured for a first task;
generating, by the first task-based agent, a first determination of whether the query includes a first ambiguity particular to the first task;
inputting the query to a second task-based agent configured for a second task;
generating, by the second task-based agent, a second determination of whether the query includes a second ambiguity particular to the second task; and
configuring the multitask prompt to include the first determination and the second determination.

12. The system as described in claim 11, wherein the first task-based agent is configured for an asset classification task and the first ambiguity indicates that the query pertains to two or more assets within a particular domain associated with the query.

13. The system as described in claim 10, wherein the generating the multitask prompt further includes editing content included in the query based on historical interaction data of a user with the machine learning model.

14. The system as described in claim 10, the operations further including receiving a response to the clarification question, generating an additional prompt for processing by the machine learning model based on the query and the response to the clarification question, and outputting a response to the query generated by the machine learning model via processing of the additional prompt.

15. The system as described in claim 10, wherein the clarification question is configured for output in a user interface of the processing device and includes selectable indicia with two or more options that are selectable to resolve the one or more task-based ambiguities.

16. The system as described in claim 10, wherein the multitask prompt includes instructions for the machine learning model to generate an ambiguity decision that indicates whether to generate the clarification question and further includes instructions to generate the clarification question.

17. A non-transitory computer-readable storage medium storing executable instructions, which when executed by a processing device, cause the processing device to perform operations comprising:
generating, by a task-based agent of a machine learning model, a determination of whether a query received for processing by the machine learning model includes an ambiguity particular to a task;
generating, by an additional task-based agent of the machine learning model, an additional determination of whether the query includes an ambiguity particular to an additional task;
configuring a prompt for processing by the machine learning model to determine whether to output a clarification question about the query, the prompt based on the query, the determination, and the additional determination; and
presenting, by the processing device, a result of the processing of the prompt.

18. The non-transitory computer-readable storage medium as described in claim 17, the operations further comprising generating, by the machine learning model and based on the prompt, the clarification question for output by the processing device.

19. The non-transitory computer-readable storage medium as described in claim 17, wherein the prompt includes instructions for the machine learning model to generate an ambiguity determination that indicates whether to generate the clarification question and further includes instructions to generate the clarification question based on the ambiguity determination.

20. The non-transitory computer-readable storage medium as described in claim 17, wherein the prompt includes a description of the task-based agent, a description of the additional task-based agent, a description of the ambiguity particular to the task, and a description of the ambiguity particular to the additional task.
